(19) United States
(12) Patent Application Publication
(10) Pub. No.: US 2026/0291035 A1
(43) Pub. Date: Sep. 24, 2026

(54) BATTERY PACK

(71) Applicant: TECHTRONIC CORDLESS GP, Anderson, SC (US)

(72) Inventors: Hei Man LEE, Hong Kong (CN); Jinhui ZHOU, Dongguan City (CN); Dianwu XU, Dongguan City (CN); Kui ZENG, Dongguan City (CN); Pei LIAO, Dongguan City (CN)

(21) Appl. No.: 19/474,136

(22) PCT Filed: Apr. 13, 2023
(86) PCT No.: PCT/CN2023/088059

§ 371 Date: Oct. 9, 2025

(51) Int. Cl. H01M 50/581; H01M 50/213; H01M 50/24; H01M 50/247; H01M 50/284; H01M 50/296

(52) U.S. Cl. CPC H01M 50/581; H01M 50/24; H01M 50/247; H01M 50/284; H01M 50/296; H01M 50/213; H01M 2200/103

(57) ABSTRACT

Embodiments described within provide a battery pack. The battery pack includes a housing, a battery cell within the housing, a printed circuit board within the housing, and a terminal contact plate holder. The terminal contact plate holder includes a base portion coupled to the printed circuit board, a plurality of terminals protruding from the base portion configured to electrically connect the battery pack to an external device, and a fuse link.

### FIELD

Embodiments described herein relate to battery packs, and more specifically, to battery packs for use with devices such as power tools.

### SUMMARY

Battery packs may experience overcurrent, overtemperature, or overvoltage situations that could damage battery cells within the battery pack. Conventionally, a fuse may be provided on a printed circuit board (PCB) in a current discharge path of the battery pack that may open or break to prevent overcurrent, overtemperature, or overvoltage situations. Conventional PCBs include a large number of components which complicate the design and layout of the PCB. Accordingly, there is a need for a fuse to be provided as a separate component to the PCB.

Embodiments described herein provide a fuse link in a terminal contact plate holder. The terminal contact plate holder includes a plurality of terminals that provide power and communication from the battery pack to the device coupled to the battery pack. The terminal contact plate holder may be a separate component from the PCB that is electrically and mechanically connected to the PCB. A cutout may be provided in the terminal contact place holder that receives the fuse link. For example, the cutout may provide heat retention that allows the fuse link to be activated with increased effectivity. Additionally, the terminal contact plate holder may include a transparent cover that provides an operator of the battery pack with a visual of the status of the fuse link.

Embodiments described herein provide a battery pack. The battery pack includes a housing, a battery cell within the housing, a printed circuit board within the housing, and a terminal contact plate holder. The terminal contact plate holder includes a base portion coupled to the printed circuit board, a plurality of terminals protruding from the base portion configured to electrically connect the battery pack to an external device, and a fuse link.

In some embodiments, the terminal contact plate holder includes a cutout provided in the base portion, and wherein the fuse link is provided in the cutout. In some embodiments, the cutout is formed from a bottom of the terminal contact plate holder. In some embodiments, the cutout includes a cantilevered portion supporting the fuse link. In some embodiments, an insulating sheet is provided below the fuse link and is separated from the fuse link by the cantilevered portion. In some embodiments, the terminal contact plate holder includes a chamber provided in the base portion, and wherein the fuse link is provided in the chamber. In some embodiments, the fuse link includes a first leg, a second leg parallel to the first leg, and a top fuse portion perpendicular to the first leg and the second leg. In some embodiments, the first leg and the second leg protrude from a bottom side of the base portion and through a first slit and second slit, respectively, in the printed circuit board. In some embodiments, the first leg is connected to the top fuse portion with a first joint and the second leg is connected to the top fuse portion with a second joint, and wherein the first joint and the second joint is one of a concave angled joint, a convex angled joint, a concave right angle joint and a convex right angle joint. In some embodiments, the terminal contact plate holder includes a clear plastic portion with a top surface that is flush with a top surface of the base portion. In some embodiments, the base portion includes a stepped portion with a first surface and a second surface, the first surface having a smaller perimeter than a perimeter of the second surface. In some embodiments, the plurality of terminals includes a positive terminal connected to a positive terminal of the battery cell and a negative terminal connected to a negative terminal of the battery cell. In some embodiments, the fuse link is provided in the terminal contact plate holder adjacent to the negative terminal. In some embodiments, the terminal contact plate holder and the housing provide a watertight seal between an exterior of the battery pack and an interior of the battery pack. In some embodiments, the terminal contact plate holder is provided with a stepped surface and a sealing ring is provided on the stepped surface. In some embodiments, fuse link is spaced from a bottom of the terminal contact plate holder.

Further embodiments provide a battery pack. The battery pack includes a housing, a plurality of battery cells within the housing, a printed circuit board within the housing, a terminal contact plate holder including, and a removable fuse link coupled to the terminal contact plate holder and the printed circuit board.

In some embodiments, the terminal contact plate holder includes a cutout that the fuse link is provided within. In some embodiments, the fuse link may be removed via the cutout. In some embodiments, the fuse link includes a first leg, a second leg parallel to the first leg, and a top fuse portion perpendicular to the first leg and the second leg.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Similarly, a component described as performing particular functionality may also perform additional functionality not described herein. For example, a device or structure that is “configured” in a certain way is configured in at least that way but may also be configured in ways that are not explicitly listed.

Other aspects of the embodiments will become apparent by consideration of the detailed description and accompanying drawings.

### BRIEF DESCRIPTION OF THE DRAWINGS

FIG. 1 illustrates a battery pack, according to some embodiments.

FIG. 2 illustrates a power tool device that receives power from the battery pack of FIG. 1, according to some embodiments.

FIG. 3 illustrates a battery module of the battery pack of FIG. 1, according to some embodiments.

FIG. 4 illustrates a terminal contact plate holder of the battery module of FIG. 3, according to some embodiments.

FIG. 5 illustrates the terminal contact plate holder of FIG. 4 without a fuse link cover, according to some embodiments.

FIG. 6 is a top view of the terminal contact plate holder of FIG. 5, according to some embodiments.

FIG. 7 is a bottom view of the terminal contact plate holder of FIG. 4, according to some embodiments.

FIG. 8 illustrates a fuse link, according to some embodiments.

FIG. 9 illustrates a cross section of a printed circuit board, according to some embodiments.

FIG. 10 illustrates the printed circuit board of FIG. 9, according to some embodiments.

FIG. 11 is a side view of the printed circuit board of FIG. 9, according to some embodiments.

### DETAILED DESCRIPTION

Embodiments described herein relate to battery packs that include a fuse link in the terminal contact plate holder. The terminal contact plate holder may be removably coupled to a printed circuit board (PCB). The fuse link may be provided in a cutout of the terminal contact plate holder and may be provided in a discharge path of the battery cells to a device (e.g., power tool) electrically connected to the battery pack. The cutout may include a transparent cover so a user using the battery pack may see the status of the fuse link (e.g., intact, melted, etc.). Heat that may result from an overcurrent situation in the battery pack may be contained in the cutout, thus speeding up the time it takes for the fuse link to melt in order to protect the battery pack well in advance of an overcurrent, overtemperature, or overvoltage situation.

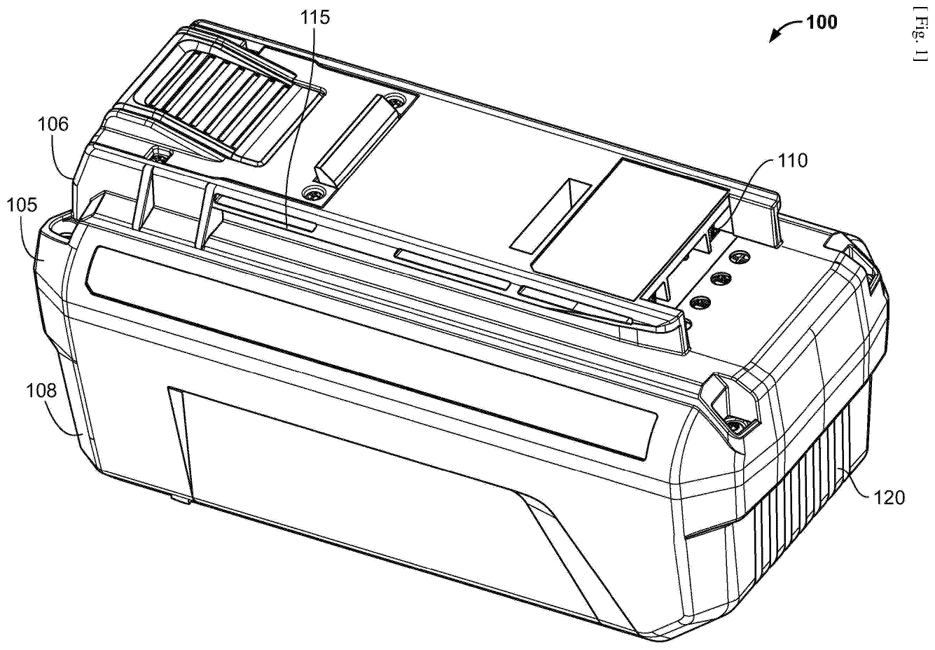

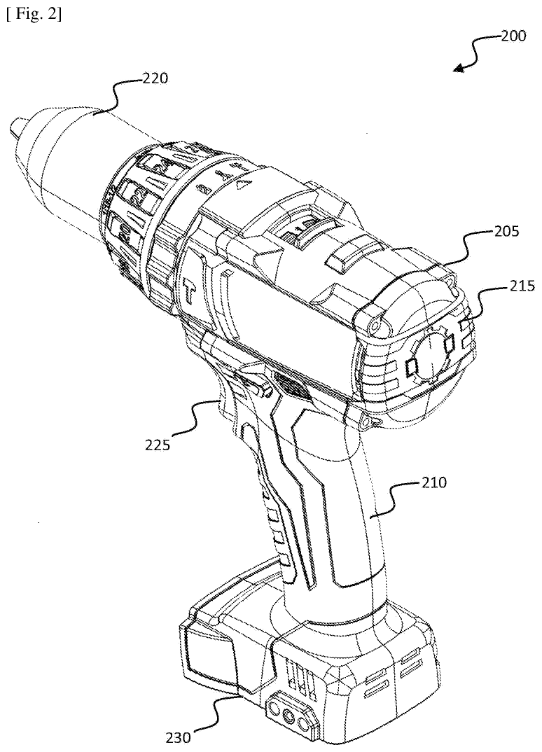

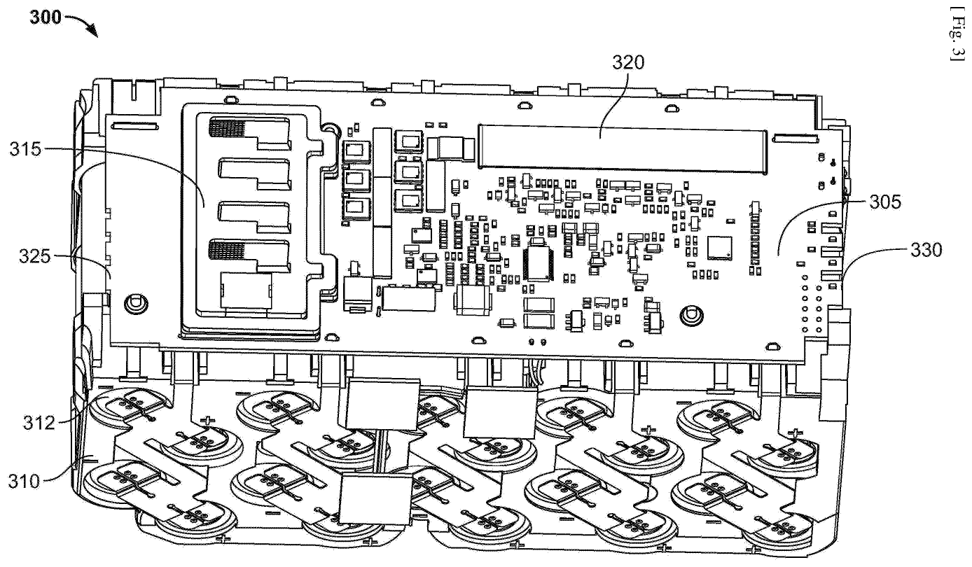

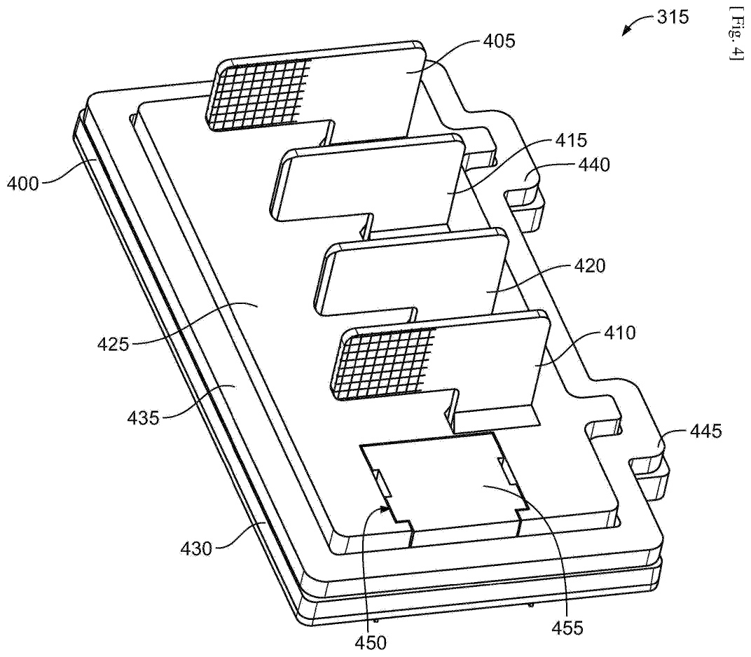

FIG. 1 illustrates a battery pack 100 according to some embodiments. The battery pack 100 includes a housing 105, a device interface portion 110, rails 115, and a vent 120. The housing 105 may include a top portion 106 and a bottom portion 108 that are connected (for example, via screws, adhesive, and/or compression). The bottom portion 108 may include a receptacle for receiving a battery module, such as battery module 300 (FIG. 3). The device interface portion 110 connects the battery pack 100 to a device, such as power tool 200 (FIG. 2) or a battery pack charger. The battery pack 100 may be slidably connected to the device via the rails 115 provided on either side of the device interface portion 110. Although illustrated as including rails 115 in the disclosed embodiment, in other embodiments the battery pack 100 may have other mechanical couplings, such as but not limited to, a stem. The rails 115 extend along a first portion of the top portion 106 of the housing 105. When the power tool 200 is slidably connected to the battery pack 100, an interface, such as interface 230 (FIG. 2) of the power tool 200, interfaces with the device interface portion 110 to form a mechanical and an electrical connection between the battery pack 100 and the power tool 200. For example, the power tool interface 230 includes terminals that connect to terminals of the battery pack 100, such as terminals 405, 410, 415, 420 (FIG. 4). The vent 120 allows gasses (e.g., air) and liquids to flow through the battery pack 100. For example, the vent 120 may be an inlet for air that is drawn through the battery pack 100 via a fan located on the opposite side of the battery pack 100 from the vent 120. The battery pack 100 may be a rechargeable battery pack that is recharged via the battery pack charger.

FIG. 2 illustrates a device, or power tool 200, according to some embodiments. The power tool 200 includes a housing 205, a handle 210, a motor housing 215, a driver 220 (e.g., a chuck or bit holder), an actuator or trigger 225, and an interface 230. The motor housing 215 sits atop the handle 210 and houses a motor. A longitudinal axis extends from the driver 220 through a rear of the motor housing 215. During operation, the driver 220 rotates about the longitudinal axis. The longitudinal axis may be approximately perpendicular with the handle 210. The motor is operated based on input from the trigger 225. Motor speed may be adjusted based on the distance of trigger travel of the trigger 225. Although illustrated as a drill/driver, the device, or power tool 200, may be a variety of electrical devices configured to be powered by a battery pack.

The interface 230 may include terminals that electrically connect the power tool 200 to the battery pack 100 and guides for reception by the rails 115 of the battery pack 100 that mechanically connect the power tool 200 to the battery pack 100. The power tool terminals may include a positive terminal, a negative terminal, and communication terminals. Power may flow from the battery pack 100 to the power tool 200 to power to motor.

FIG. 3 illustrates a battery module 300, according to some embodiments. The battery module 300 may be received by the bottom portion 108 of the battery pack housing 105 and includes a printed circuit board (PCB) 305 and a battery cell holder 310. In some embodiments, the PCB 305 sits on top of the battery cell holder 310. The battery cell holder 310 houses one or more (e.g., a plurality of) battery cells 312. In the illustrated embodiment, the plurality of battery cells 312 are cylindrical cells that are electrically connected to provide a desired output (e.g., nominal voltage, current capacity, etc.) of the battery pack 100. However, in other embodiments, the battery cells 312 may be pouch battery cells, prismatic cells, or any other suitable battery cell. In the illustrated construction, the battery module 300 includes 20 battery cells 312. In further constructions, the battery pack 100 may alternatively include fewer or more than 20 battery cells 312, and the battery cells 312 may be electrically coupled in any series or parallel combination. The illustrated battery pack 100 has a nominal output voltage of at least 18 volts (V). The battery cells 312 may have a Lithium-based chemistry (e.g., Lithium, Lithium-ion, etc.) or any other suitable chemistry.

The PCB 305 includes a terminal contact plate holder 315, a busbar 320, and control circuitry for controlling operation of the battery pack 100. The terminal contact plate holder 315 may be manufactured as a separate component from the PCB 305 and then coupled to the PCB 305 during assembly of the battery pack 100. For example, the terminal contact plate holder 315 may be welded or connected via screws, an adhesive, or compression on the surface of the PCB 305. In some embodiments, the PCB 305 may include a cutout that the terminal contact plate holder 315 is fitted into. The terminal contact plate holder 315 may be provided at a first end 325 of the PCB 305 and will be described in detail below with respect to FIG. 4. The first end 325 of the PCB 305 is opposite a second end 330 of the PCB 305. In some embodiments, the terminal contact plate holder 315 may be provided at the second end 330 of the PCB 305. In some embodiments, the busbar 320 is composed of copper (or other suitable conductive material) and provides a path for power from the battery cells 312 to the terminal contact plate holder 315. In some embodiments, the PCB 305 is substantially rectangular in shape with two short edges provided at the first end 325 and the second end 330.

FIG. 4 illustrates the terminal contact plate holder 315, according to some embodiments. The terminal contact plate holder 315 includes a base portion 400 and terminals 405, 410, 415, 420 protruding from the base portion 400. The terminals include a positive terminal 405, a negative terminal 410, a first communication terminal 415, and a second communication terminal 420. However is other embodiments the contact plate holder 315 could have more or less terminals, for example, but not limited to, more or less communication terminals. The base portion 400 may include multiple surfaces in a stepped configuration. For example, the base portion 400 includes a first surface 425, a second surface 430, and a sealing ring 435. The first surface 425 may be the greatest distance from the PCB 305, followed by the second surface 430. In some embodiments, the second surface 430 is a first stepped distance and the first surface 425 is a second stepped distance from the second surface 430. Alternatively, in some embodiments, the stepped distances between the surfaces 425, 430 may be different the same. The perimeters of the surfaces 425, 430 may include 12 sides including a first long side, two short sides parallel from one another and perpendicular to the first long side, and protrusions 440, 445 along a third side that is parallel to the first long side. In some embodiments, the protrusions 440, 445 may accommodate the extra metal of the positive terminal 405 and the negative terminal 410, compared to the first communication terminal 415 and the second communication terminal 420. In some embodiments, the base portion 400 is comprised of an opaque material, such as an opaque plastic. Alternatively, in some embodiments, the base portion 400 is comprised of a clear material, such as a clear plastic. In some embodiments, just the first surface 425 is a clear material and the second surface 430 is an opaque material. The sealing ring 435 may be provided substantially on top of the second surface 430 and provide a water-tight seal between an exterior of the battery pack 100 and an interior of the battery pack 100. In some embodiments, the sealing ring 435 may be an elastic material, such as but not limited to rubber or a rubber-like compound.

A cutout 450 may be provided in the terminal contact plate holder 315. in some embodiments, the cutout 450 is formed from the bottom of the terminal contact plate holder 315 through the base portion 400. In some embodiments, the cutout 450 is provided at the first short side, adjacent to the negative terminal 410, of the first surface 425. Alternatively, the cutout 450 may be provided at the second short side, adjacent to the positive terminal 405. The cutout 450 may be provided throughout both stepped surfaces 425, 430 of the base portion 400. The cutout 450 may include a first edge that is centered along the first short side. In some embodiments, the cutout may include eight edges including a back edge, two side edges parallel to one another and perpendicular to the back edge, a front edge that is parallel to the back edge, and two right angle edges that join the front edge to the side edges. In some embodiments, the cutout 450 is a chamber.

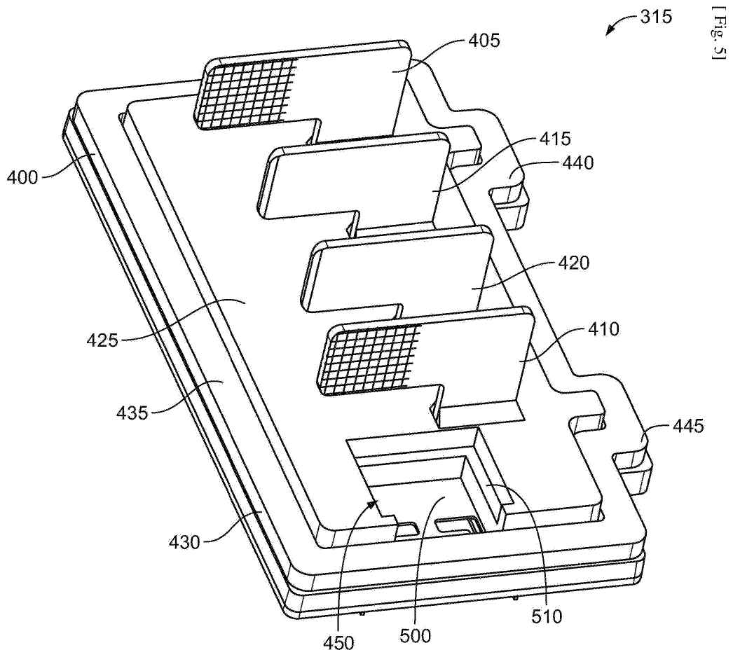

A fuse link, such as fuse link 500 (FIG. 5) may be provided within the cutout 450. The fuse link 500 may by a fusible material and may be provided in a current path of the battery pack 100 to provide protection in case of an event that could potentially damage the battery pack 100 (e.g., a hard short event, an overcharging event, or when the current flowing through the battery pack 100 exceeds a predetermined limit). A fuse link cover 455 may be fitted in the cutout 450. In some embodiments, the fuse link cover 455 is comprised of a clear plastic to provide a visual of the status of the fuse link 500 (e.g., intact, melted, broken, etc.) to a user. In some embodiments, the fuse link cover 455 is omitted. For example, when the base portion 400 is comprised of a clear material, the fuse link cover 455 may be omitted. In some embodiments, the fuse link cover 455 includes indents that provide a user with a slot to remove the fuse link cover 455 from the cutout 450 (for example, by using a tool such as a screwdriver). In some embodiments, the fuse link cover 455 is a thickness of the first surface 425 (e.g., the first stepped distance) and flush with the first surface 425. Alternatively, the fuse link cover 455 is a fraction of the thickness of the first surface 425. In some embodiments, there is a gap between the fuse link 500 and the fuse link cover 455.

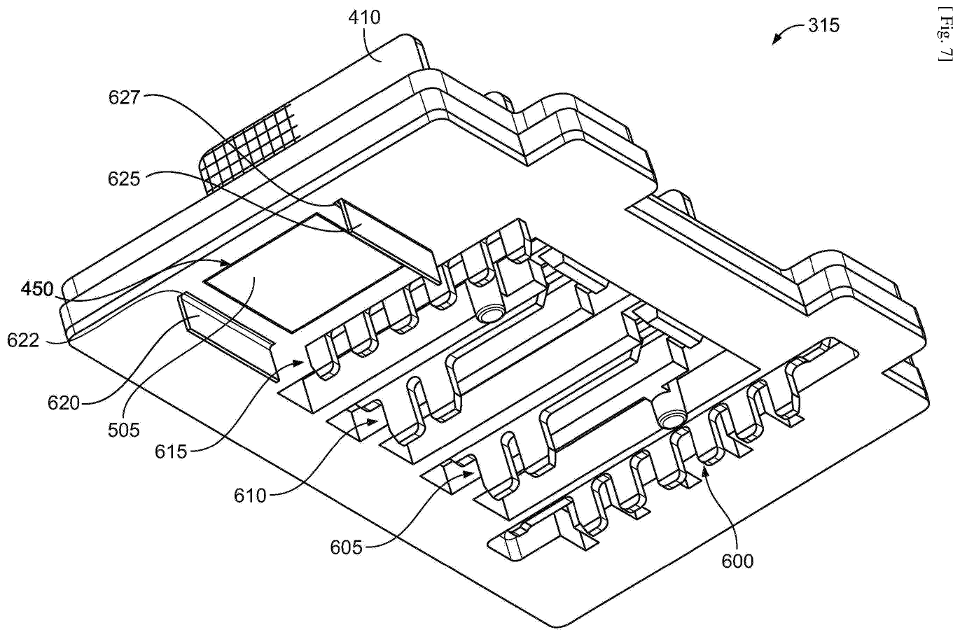

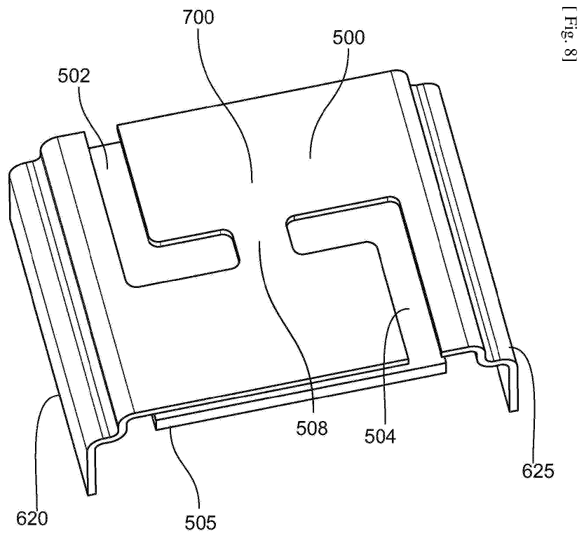

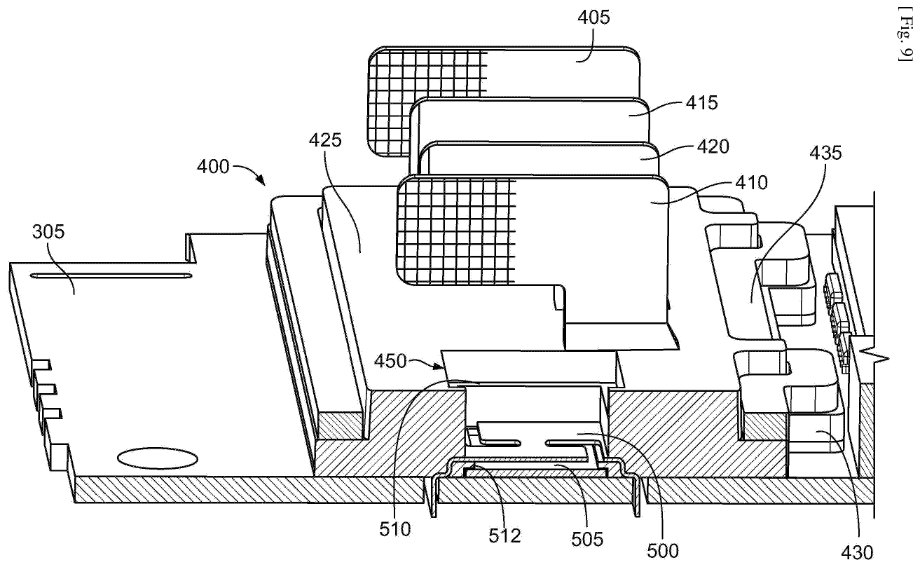

FIG. 5 illustrates the terminal contact plate holder 315 without the fuse link cover 455 according to some embodiments. The fuse link 500 includes a first leg, such as first leg 620 (FIG. 7), a second leg, such as second leg 625 (FIG. 7), and a top fuse portion, such as top fuse portion 700 (FIG. 8), and is provided in the cutout 450. In some embodiments, the fuse link 500 is integrally formed in the terminal contact plate holder 315. The cutout 450 includes a stepped surface 510. In some embodiments, the stepped surface 510 supports the fuse link cover 455. For example, part of the fuse link cover 455 may rest on the stepped surface such that the fuse link cover does not contact the fuse link 500. In some embodiments, the stepped surface 510 may be on the same plane as the second surface 430 of the base portion 400. For example, the stepped surface 510 may be the first stepped distance from the first surface 425. In some embodiments, the cutout 450 may include more than one stepped surface. The fuse link 500 is provided at the bottom of the cutout 450. In some embodiments, an insulative material 505 (FIG. 7) is provided under the fuse link 500. For example, the insulative material 505 may be coupled to the PCB 305 (as shown in the FIG. 9). The insulative material 505 may be a mica sheet which serves as an insulator between the fuse link 500 and the PCB 305. In some embodiments, the insulative material 505 may be omitted. For example, the fuse link 500 may be provided above and spaced (for example, via an air gap) from a bottom portion of the terminal contact plate holder 315. In some embodiments, the cutout 450 may be provided along a short side of the first surface 425. For example, the first edge of the cutout 450 may be along the short side of the first surface 425 and the back edge may be provided in the first surface 425. In the illustrated embodiment, the fuse link 500 is coupled between the negative terminal 410 and at least one terminal of at least one battery cell of the plurality of battery cells 312.

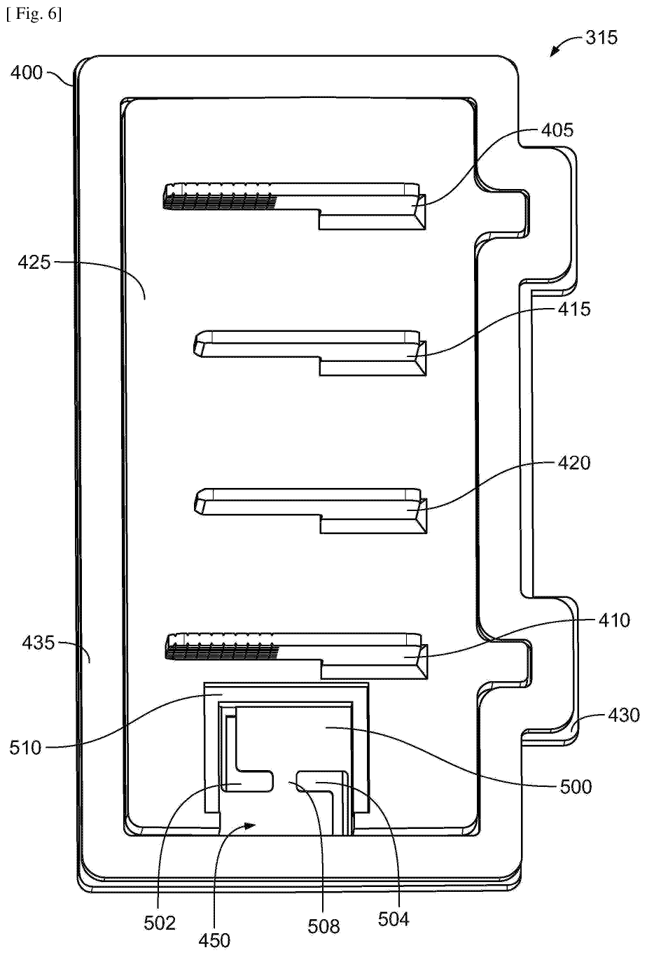

FIG. 6 is a top view of the terminal contact plate holder 315 according to some embodiments. In the illustrated embodiment, the fuse link 500 fills the entirety of the cutout 450. The fuse link 500 may include a first window 502 and a second window 504 that expose the insulative material 505 and provide visual clarity to the fuse link 500. For example, the first window 502 and the second window 504 are separated via a bridge 508 of the fuse link 500. When exposed to high temperatures that may be a result of overcurrent, overvoltage, and/or overtemperature conditions, the bridge 508 of the fuse link 500 breaks (or melts) onto the insulative material 505, which can then be seen by a user in contrast to the mica of the insulative material 505 that is shown through the first window 502 and the second window 504. In the illustrated embodiment, the first window 502 is substantially “L” shaped and the second window 504 is a 180° rotation of the “L” shape of the first window 502. In some embodiments, the first window 502 and the second window 504 may be shaped like half-spheres, triangles, trapezoids, etc. In the illustrated embodiment, the bridge 508 is made of the same metal as the top fuse portion 700 and may be a smaller width than the top fuse portion 700, the first leg 620, and/or the second leg 625 (FIG. 8). In other embodiments, the bridge 508 may be made of the same metal as the top fuse portion 700, the first leg 620, and/or the second leg 625 (FIG. 8) and may have a smaller thickness than the top fuse portion 700, the first leg 620, and/or the second leg 625 (FIG. 8). In even further embodiments, the bridge 508 may be made of a different material than the top fuse portion 700, the first leg 620, and/or the second leg 625 (FIG. 8). For example, the material may have a lower melting point than the top fuse portion 700, the first leg 620, and/or the second leg 625. In some embodiments, the fuse link 500 is replaceable via the cutout 450 after the bridge 508 breaks (or melts). For example, the fuse link 500 may be removable from the terminal contact plate holder 315 and a new fuse link may be inserted into the terminal contact plate holder 315 via the cutout 450. However, in other embodiment described herein, the entire terminal contact plate holder 315 may be removable when the bridge 508 of the fuse link 500 breaks (or melts).

FIG. 7 is a bottom view of the terminal contact plate holder 315 according to some embodiments. Terminal connection portions 600, 605, 610, 615 are provided that correspond with the terminals 405, 410, 415, 420. For example, a positive terminal connection portion 600 corresponds to the positive terminal 405, a first communication terminal connection portion 605 corresponds to the first communication terminal 415, a second communication terminal connection portion 610 corresponds to the second communication terminal 420, and a negative terminal connection portion 615 corresponds to the negative terminal 410. The insulative material 505 may be flush with a bottom of the base portion 400 of the terminal contact plate holder 315. For example, the cutout 450 may be substantially square shaped at the bottom of the base portion 400 and the insulative material 505 may also be substantially square shaped and fill the cutout 450 at the bottom of the base portion 400 of the terminal contact plate holder 315 (FIG. 6). In some embodiments, the cutout 450 may be formed in the bottom of the terminal contact plate holder 315. In this configuration, the terminal contact plate holder 315 is preferably made by transparent material so that a user may check the status of the fuse link 500 from the first surface 425. The advantage of forming the cutout from the bottom of the terminal contact plate holder 315 is that the terminal contact plate holder 315 can provide a water-proof function (e.g., using the sealing ring 435). The housing of the battery pack 100 may form a water-proof engagement with the first surface 425 of the terminal contact plate holder 315.

The first leg 620 and the second leg 625 of the fuse link 500 may protrude from the bottom of the base portion 400 of the terminal contact plate holder 315 (FIG. 6). For example, the base portion 400 may include a first slit 622 on a first side of the cutout 450 and a second slit 627 on a second side of the cutout 450, parallel to the first side. The first leg 620 and the second leg 625 of the fuse link 500 may extend a same distance from the bottom of the base as the positive terminal connection portion 600 and the negative terminal connection portion 615.

FIG. 8 illustrates the fuse link 500 according to some embodiments. The top fuse portion 700 is connected to the first leg 620 on a first side via a concave angled joint and to the second leg 625 on a second side, parallel to the first side, via another concave angled joint. The first leg 620 and the second leg 625 are then electrically connected via the bridge 508. In the illustrated embodiment the concave angled joints have curved characteristics, however, convex angled joints with curved characteristics, concave right-angled joints, and convex right-angled joints are also contemplated. In some embodiments, each side of the top fuse portion 700 is the same length, thus, the top fuse portion 700 is substantially square-shaped. In some embodiments, the insulative material 505 is substantially rectangular-shaped with a length that is the same as the length of the top fuse portion 700 and a width that is less than the length of the top fuse portion 700. As described above, the first window 502 and the second window 504 are separated by the bridge 508 that may be broken (or melted) when the fuse link 500 is activated.

FIG. 9 illustrates a cross section of the PCB 305 according to some embodiments. The cutout 450 has a depth equal to the total height of the first surface 425 and the second surface 430. The cutout 450 may further include a cantilevered portion 512 that is a same thickness as a distance between a top of the insulative material 505 and a bottom of the top fuse portion 700 of the fuse link 500. In some embodiments, the cantilevered portion 512 protrudes from a wall of the cutout 450 on all sides of the cutout 450 to provide a tight fitting space that retains the insulative material 505. For example, the tight fitting space retains the insulative material 505 in order to prohibit the insulative material 505 from shifting and contacting the fuse link 500.

In some embodiments, the stepped surface 510 of the cutout 450 is a first distance from the top of the first surface 425 and a second distance, greater than the first distance, from the PCB 305. Alternatively, in some embodiments, the stepped surface 510 of the cutout 450 is a first distance from the top of the first surface 425 and the first distance from the PCB 305. The stepped surface 510 creates a cutout stepped portion including a first cutout aperture (above the stepped surface 510) and a second cutout aperture (below the stepped surface 510). The first cutout aperture may have a larger perimeter than the second cutout aperture. For example, the cutout 450 may decrease in size closer to the PCB 305. In some embodiments, the cutout 450 is centered along the center of the negative terminal 410. Alternatively, in some embodiments, the cutout 450 may be shifted to the right or left of the center of the negative terminal 410.

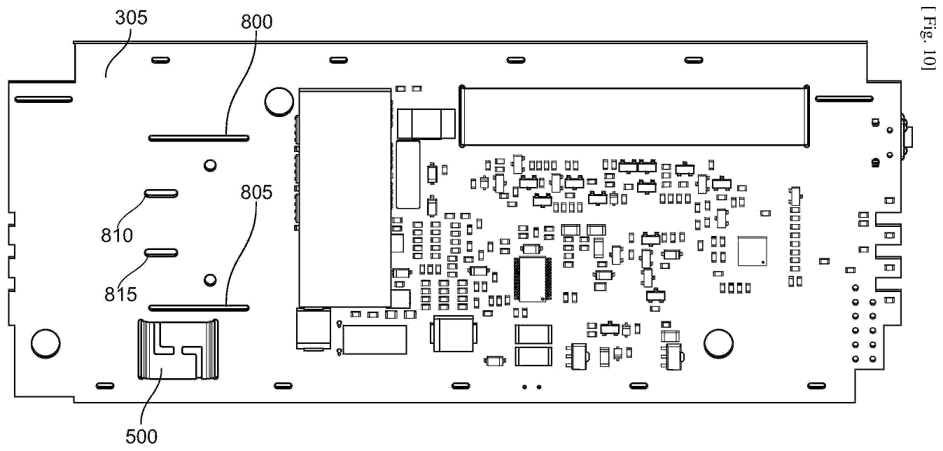

FIG. 10 illustrates the PCB 305 with the fuse link 500 isolated from the base portion 400 of the terminal contact plate holder 315 according to some embodiments. The PCB 305 may include a first terminal slit 800, a second terminal slit 805, a third terminal slit 810, and a fourth terminal slit 815. The terminal slits 800, 805, 810, 815 correspond with the terminals 405, 410, 415, 420. For example, the first terminal slit 800 corresponds to the positive terminal 405 and receives the positive terminal connection portion 600, the second terminal slit 810 corresponds to the negative terminal 410 and receives the negative terminal connection portion 615, the third terminal slit 810 corresponds to the first communication terminal 415 and receives the first communication terminal connection portion 605, and the fourth terminal slit 815 corresponds to the second communication terminal 420 and receives the second communication terminal connection portion 610. In the illustrated embodiment, the fuse link 500 is provided adjacent to the second slit 805. In some embodiments, the fuse link 500 is provided away from the circuit components on the PCB so as to not absorb any heat that the circuit components emit that could cause the bridge 508 of the fuse link 500 to melt.

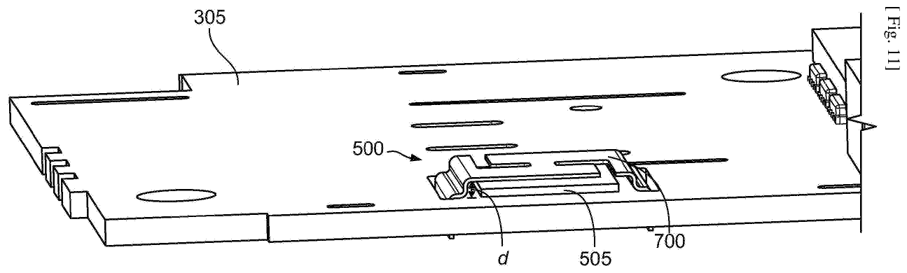

FIG. 11 is a side view of the PCB 305 with the fuse link 500 but without the base portion 400 of the terminal contact plate holder 315 according to some embodiments. The top fuse portion 700 of the fuse link 500 may be offset from the PCB 305 a first offset distance d. The first offset distance d may be the same distance as a height of the curved angle joint. A second offset distance (not shown) between the insulative material 505 and the top fuse portion 700 may be less than the first offset distance d. The second offset distance may allow the fuse link 500 to break.

Thus, embodiments described herein provide, among other things, a fuse link provided in a terminal contact assembly that is coupled to a printed circuit board of a battery pack. Various features and advantages are set forth in the following claims.

1. A battery pack comprising:
a housing;
a battery cell within the housing;
a printed circuit board within the housing; and
a terminal contact plate holder including:
a base portion coupled to the printed circuit board,
a plurality of terminals protruding from the base portion configured to electrically connect the battery pack to an external device, and
a fuse link.

2. The battery pack of claim 1, wherein the terminal contact plate holder includes a cutout provided in the base portion, and wherein the fuse link is provided in the cutout.

3. The battery pack of claim 2, wherein the cutout is formed from a bottom of the terminal contact plate holder.

4. The battery pack claim 2, wherein the cutout includes a cantilevered portion supporting the fuse link.

5. The battery pack of claim 4, wherein an insulating sheet is provided below the fuse link and is separated from the fuse link by the cantilevered portion.

6. The battery pack of claim 1, wherein the terminal contact plate holder includes a chamber provided in the base portion, and wherein the fuse link is provided in the chamber.

7. The battery pack of claim 1, wherein the fuse link includes a first leg, a second leg parallel to the first leg, and a top fuse portion perpendicular to the first leg and the second leg.

8. The battery pack of claim 7, wherein the first leg and the second leg protrude from a bottom side of the base portion and through a first slit and second slit, respectively, in the printed circuit board.

9. The battery pack of claim 7, wherein the first leg is connected to the top fuse portion with a first joint and the second leg is connected to the top fuse portion with a second joint, and wherein the first joint and the second joint is one of a concave angled joint, a convex angled joint, a concave right angle joint and a convex right angle joint.

10. The battery pack of claim 1, wherein the terminal contact plate holder includes a clear plastic portion with a top surface that is flush with a top surface of the base portion.

11. The battery pack of claim 1, wherein the base portion includes a stepped portion with a first surface and a second surface, the first surface having a smaller perimeter than a perimeter of the second surface.

12. The battery pack of claim 1, wherein the plurality of terminals includes a positive terminal connected to a positive terminal of the battery cell and a negative terminal connected to a negative terminal of the battery cell.

13. The battery pack of claim 12, wherein the fuse link is provided in the terminal contact plate holder adjacent to the negative terminal.

14. The battery pack of claim 1, wherein the terminal contact plate holder and the housing provide a watertight seal between an exterior of the battery pack and an interior of the battery pack.

15. The battery pack of claim 14, wherein the terminal contact plate holder is provided with a stepped surface and a sealing ring is provided on the stepped surface.

16. The battery pack of claim 1, wherein fuse link is spaced from a bottom of the terminal contact plate holder.

17. A battery pack comprising:
a housing;
a plurality of battery cells within the housing;
a printed circuit board within the housing;
a terminal contact plate holder including; and
a removable fuse link coupled to the terminal contact plate holder and the printed circuit board.

18. The battery pack of claim 17, wherein the terminal contact plate holder includes a cutout that the fuse link is provided within.

19. The battery pack of claim 18, wherein the fuse link may be removed via the cutout.

20. The battery pack of claim 17, wherein the fuse link includes a first leg, a second leg parallel to the first leg, and a top fuse portion perpendicular to the first leg and the second leg.
